(19) United States
(12) Patent Application Publication
(10) Pub. No.: US 2007/0124257 A1
(43) Pub. Date: May 31, 2007

(54) Builders service program system and method

(76) Inventor: Dave Kowalczyk, Rosemount, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/517,143

(22) Filed: Sep. 7, 2006

Related U.S. Application Data
(60) Provisional application No. 60/714,592, filed on Sep. 7, 2005.

(51) Int. Cl. G06F 17/00; G06G 7/00

(52) U.S. Cl. 705/400

(57) ABSTRACT

A system and method for using a service network that provides services for customers. The operation of the service network comprises requesting a service from a service provider in the network, execution of the service for member customers, payment of an amount to the service provider for the service and receiving a first fraction of the amount paid to service provider as discount that is credited into a member customer account. Additionally, the network program receives a second fraction of the amount paid to service provider and uses the mount to manage the network program.

### CROSS-REFERENCE TO RELATED APPLICATIONS

This Non-Provisional Utility Patent Application claims the benefit of the filing date of U.S. Provisional Patent Application Ser. No. 60/714,592, filed Sep. 7, 2005, entitled “BUILDERS SERVICE PROGRAM SYSTEM AND METHOD,” which is incorporated herein by reference.

### FIELD OF THE INVENTION

The present invention relates to the field of construction and building services. More specifically, the present invention relates to a business method to ensure efficient and cost effective service for homeowners during construction and home improvement.

### BACKGROUND

Investing money in one's property is an important decision. Homeowners often experience stress when deciding to have someone work on their property. The stress is mostly due to the uncertainties associated with ensuring that the money is invested wisely and economically. Often, the estimation and guessing involved in making these decisions contribute to the stress. To solve this dilemma, a network of available and reliable service providers may be useful. Currently, there are some service networks available that are used by builders and contractors. However, these current networks of service providers do not cater to, and thus fail to, benefit homeowners. Instead, they provide benefits and discounts to contractors and builders. The cost savings from using the service providers available within the network is generally not passed onto the consumer or homeowner. For the above reasons and other reasons, there is a need to provide a network of service providers for homeowners that would provide benefits and discounts directly to the homeowners.

### SUMMARY

One embodiment of the invention provides a method for using a service network that to caters services for customers. The operation of the service network comprises requesting a service from a service provider in the network, execution of the service for member customers, payment of an amount to the service provider for the service and receiving a first fraction of the amount paid to service provider as a discount that is credited into a member customer account. Additionally, the network program receives a second fraction of the amount paid to service provider and uses the amount to manage the network program.

### BRIEF DESCRIPTION OF THE DRAWINGS

FIG. 1 illustrates a network program according to one embodiment of the present invention.

FIG. 2 illustrates a flow diagram of a method according to one embodiment of the present invention.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

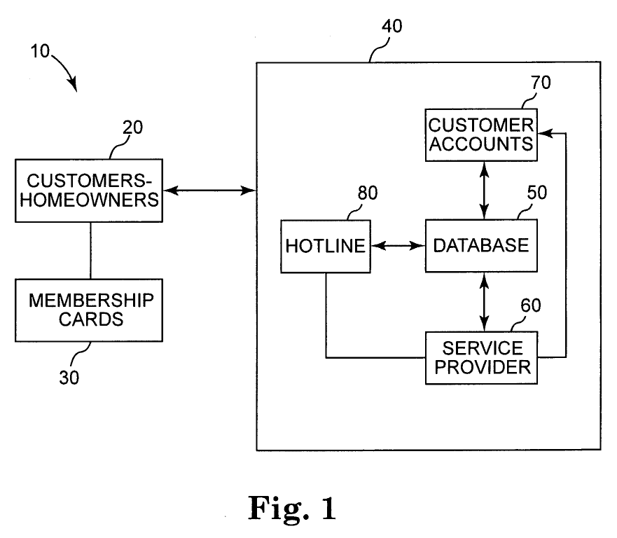

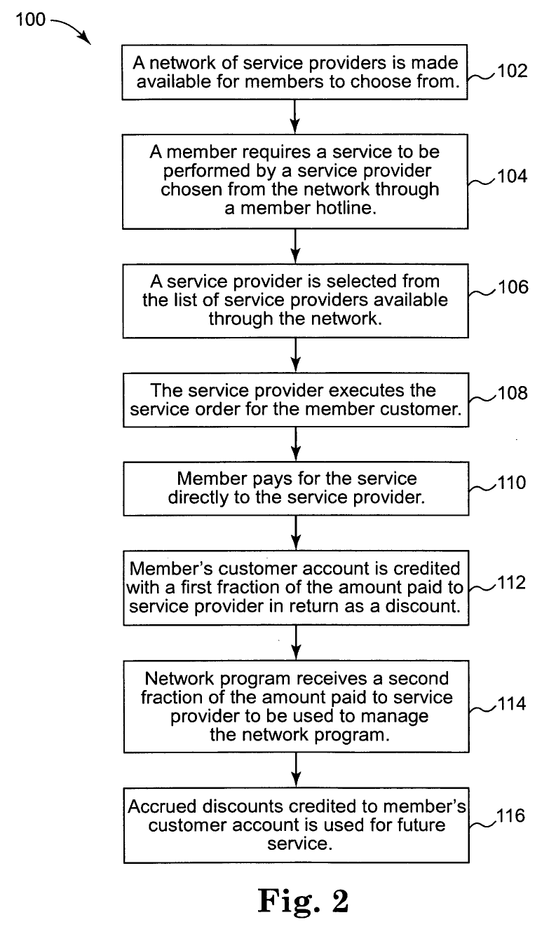

In the following detailed description, reference is also made to FIG. 1 and FIG. 2.

In one embodiment, Serv-S-Team is a network program 10 (or network 10) including a number of qualified reputable professionals with long successful track histories in the industry of construction, remodeling, restoration, home improvement as well as other frequently used services (hereafter referred to as service providers or providers). In one embodiment, the network program 10 includes customers 20 in possession of membership cards 30, where the customers 20 access a system 40 that includes a database 50 in electrical communication with service providers 60, customer accounts 70, and a hotline 80.

The providers 60 have joined an alliance group which represents the network 10. These providers 60 have agreed via contract with the network 10 to participate in Serv-S-Team. Each provider 60 will agree to pay the program a discount rate which in turn is given back to the consumer 20 for further usage of services within the network which earn them a return referred to as rewards.

One purpose of this network 10 is to supply to the consumer, the widest variety of specialty services possible to accomplish most needs within the construction and servicing industry while creating a way of savings for future necessities, wants or emergencies in the future. This will not only create an easy way for consumers to find the right service for their needs, but will also create an enormous support group with great knowledge base that can research and supply much more useful information for the consumer to insure the most economical and efficient way to accomplish the consumers goal is reached. In addition, it supplies a comfort and confidence level to the consumer that they are receiving a more consistent quality service via its own recommendations of other member consumers within the network. It also creates a way for the providers to benefit by wider capacity of word of mouth referrals and repeat business as well as saving large amounts of advertising costs. This plan encourages small business growth, creating more job opportunities, stability and lower risk to the providers being most work would mostly be referred and pre-qualified resulting in payments being made in a more timely fashion.

The Serv-S-Team committee first chooses qualified providers with an established, reputable, with a strong track record in the market. Each provider is closely qualified based on their history performance, referrals, and credit checks. Potential providers will have financial stability and the ability to handle higher volume of work with growth potential. Each provider will also be required to have necessary workers comp and liability insurance as well as proper certifications and licenses in their specialized field. They will also be required to have a warranty plan in place acceptable to the network. Potential providers will also be required by the network to sign a legal agreement to terms and conditions of the program.

In one embodiment, the program will include the following trades of contractors and services: Building contractors (General Contractors), new home construction Remodeling contractors, Restoration contractors, Commercial contractors, Electrical plumbing and heating, Framing, Insulating, roofing, siding and gutters, masonry, cabinetry, flooring and floor finishing, painting, countertops, doors and windows, furniture restoration, fireplaces, Architecture, Printing, Interior design, audio and video, appliances, game room designing and merchandise, landscaping, lawn care service, snow removal services, Indoor air quality services, mold remediation services, Disaster recovery services (fire, smoke damage, water, flood, storm). Serv-S Plus also has financing available if needed. Providers within the program instantly become members of the board of the program that have the say and input regarding future development as well as future applying providers to be accepted into the program.

Once the providers have been selected the Program representative will hold a meeting with all providers to explain in great detail, the programs functions goals and objectives as well as outlines, policies and procedures. At this time advertising material will be disbursed.

With reference to FIG. 2, one embodiment of the network program 10 includes a method of providing service within the network 10 (FIG. 1) illustrated by a flow diagram 100. The flow diagram 100 includes a process 102 that provides a network of service providers made available for members from which a desired provider is selected. The flow diagram 100 additionally includes a process 104 where a member who requires a service to be performed by a service provider chooses that provider from the network through a member hotline. The flow diagram 100 also includes a process 106 where a service provider is selected from the list of service providers available through the network. Process 108 enables the service provider to execute a service order specified by the member customer. Process 110 enables the member to pay for the service directly to the service provider, for example, via an electronic debit card or the member card 30 (FIG. 1). Process 112 provides for the member customer account to be credited with a first fraction of an amount paid to the service provider in return as a discount. Process 114 provides a network program that receives a second fraction of the amount paid to the service provider to be used to manage the network program. Process 116 provides that accrued discounts credited to a member customer account is available and used for future service. With the above in mind, the following examples illustrate further embodiments of the present invention.

Membership Card 30

In one embodiment, each provider will receive a quantity of Serv-S-Team booklets which will have list of providers, address and telephone numbers. It will also contain a member information form with a temporary card (similar to credit cards) which will all have a random account number on each individual card. These cards represent the membership cards 30 to be disbursed by the provider to its previous, present or future customers 20 via their marketers, salespeople, estimators as well as other authorized employees.

These credit cards initially will only have Serv-S-Team with hotline number and a random code number printed on the card. Providers' personnel will disburse per their individual company marketing and sales structure and strategy to pretty much anyone. Providers do not need to ask consumer for any personal information at this time. These cards only become active upon first usage with any of the service providers within the network. At and only at that time will the provider ask for the clients' personal information being Name, address, and contact phone numbers. Upon the first usage Providers will gather information via network membership form and submit information to the Serv-S-Team main office. The information will be entered and a new member account will be created. The member's number will be consistent with the temporary card from booklet. This will be their account number for future reference. At that time the network will send them a personalized card with their name and account number on it indicating in the future to providers that their client is an active member in the program.

Benefit to Providers 60

In one embodiment, this plan of disbursement is beneficial to all providers within the network as they all are being equally advertised and recognized with little to no advertising expense. It becomes more efficient and economical advertising than the more customary ways, due to the fact it is being brought to each potential client in person whom of which may be in a more potentially active status. The biggest benefit is providers have all the rest of the providers doing the same thing making it a wider regional spread of direct advertising which would be in turn very costly to run on ones own. Providers also benefit by significantly lessoning competition being there may only be a couple of other related providers in the network. This becomes necessary to have multiple choices of related services so the consumer may feel more confident that they are receiving the most competitive bid without leaving the network as well as the Serv-S-Team wants to insure that timely service will be accomplished regardless of the volume or locations.

Benefit to Consumer 20

In one embodiment, the consumer benefits from this plan by being assured that they are receiving the same and in most cases better competitive bids as if they were outside the program. They also have the piece of mind knowing the providers are all pre-qualified, properly licensed, well established with great track histories as well as true professionals within the industry. They also have a wider base of references from those other members who have been active within the plan. This plan also eliminates the confusion and frustration of having to find the right resources when in time of need as well as wondering if you have chosen the right company itself. Best of all, every dollar spent is earning them more buying power in the future for not only wants and needs but also for times of unforeseen emergencies that can damage the stability of ones financial position. Once a member of the program its members become top priority in times of disasters such as Wind, Storms, Fires or Floods as well as other Insured or un-insured situations. One call for most any needs supplies the results to the need. Thus, it creates consistency.

How the Program 10 Works

In one embodiment, each new member will receive a booklet which will be complete with the names, numbers, addresses, and summarized descriptions of the services of each Provider within the network. Upon the need of a specific service the member will then contact that provider, without obligation, and will arrange a time to meet and discuss the need at hand and request for an estimate of services. The client can call as many or as few providers as see fit. The client may also call other companies outside the network if they wish for competitive bids. However, the plan would not honor the rewards system with any company outside the network. Once the client makes the decision to proceed with a provider within the network the appropriate contracts would be signed and work would be scheduled per the providers' availability. Upon completion of the contracted work and final payment has been paid, the provider will submit a required document by the network plan, a customer satisfaction and completion of work form indicating all work has been successfully completed to the customers satisfaction and the work has been paid in full. At that time the transaction would be complete and the appropriate forms submitted to Serv-S-Team home base. The transaction would be calculated to give the client the points or rewards proportional to the transaction. The agreed % of total sale is then registered into that specific customers account where it will be available for future uses (for example, 7% would be the overall discount) of which a % would go to the program for operational costs and expenses to maintain and further develop program.

### EXAMPLE

Client hires a network provider to perform a $40,000 remodel. Provider submits to the plan 7% or $2800 to the Network Plan of which 5% or $2000goes into the clients' membership account and 2% or $800 goes to Serv-S-Team for company operations.

At that time the Serv-S-Team member now has $2000 in their account for future use. Now let's say a month down the road the member has a want to put say a fireplace in due to winter setting in. The member then contacts the related provider in the network and has them come out to price one to put in. The fire place estimate is $1185 at which time the member may then except the proposal and sign the appropriate contracts. When contract is satisfied to the members' approval they will then decide whether or not they would like to use their account rewards or not. If they choose to use their account they simply have the provider submit their invoice directly to Serv-S Plus with the appropriate sign off from the client and we will then process the check and submit directly to the client to pay the provider. In this case a check for $1185 would be sent to the member which would be made out in the members name and the Providers name. This insures both that the amount is correct and also insures the provider receives payment. The member may wish to have the check directly sent to the Provider without going to them first. This may be implemented via a direct payment request form that can be signed and submitted to Serv-S-Team authorizing us to do so. In this case a copy of check and receipt would be sent to member for their records. The member would be left with balance of $815.00 in their account. Statements would then be submitted to the member with a history of activity and current balance within the account. This gives the member an opportunity to check the accuracy of the history and to inform Serv-S Plus of any discrepancies.

If the member at this time does not choose to claim account rewards they follow the same process as their last transaction or as follows:

They pay the contract amount to the Provider, the appropriate forms get forwarded to Serv-S-Team and the member now has and additional $59.25 ($1185 @ 5%) in their account bringing the total available credit to use to a balance of $2059.25. (Previous balance=$2000+$59.25) for future use. Note: A customer does not earn rewards while using rewards from their account. In other words, a member would not earn rewards on the first $2000 being used from their account. However, a member would earn rewards on anything above and beyond that $2000 amount. Example: The fireplace came to $2500 instead of the original $1185. Account funds of $2000 would be paid out leaving a balance of $500 to the member to pay out of pocket. That $500 is now given the applicable return rate of 5% or $25.00 to be placed into the members account. The process continues thereafter.

The above scenarios are all considered to be voluntary needs. Let's now talk about situations that members may experience under unforeseen, uncontrollable circumstances. This is how our Plan highly benefits our members.

### EXAMPLE

The member has a fire in their house. A network provider would be contacted that specializes in emergency response and restoration services. This provider is a licensed, certified and trained professional experienced with dealing with insurance claims and the Insurance carriers.

Scenario:

The provider comes to an agreed amount of repairs to the sum of $150,000 with the insurance company. The work is performed and you the client at the end of the project receive the check from the insurance company to pay for the providers services and the payment to the provider is paid in full. The member now has been credited to their account $150,000 at the applicable rate of 5% equaling $7500 readily available to use. They have earned rewards without taking a penny out of their pocket. ** Rewards may not be used until paid transactions have been completed.

Serv-S-Team has many benefits and conveniences for the consumer. Nothing can be more stressful than the uncertainties of who to hire as well as what steps should be taken to insure your money is being invested with the most economical resources as well as the highest quality of workmanship. Serv-S-Team takes the guesswork out of doing that by qualifying and researching all of its providers insuring the consumer receives a quality service and or product. Next, the consumer actually sees that they are getting a discount rate because it is in their account. Serv-S-Team insures true discounts are applied based on competitive rates within the industry. This plan also makes it easy to get answers and direction, with no multiple calls and researching to find out information. Serv-S-Team has someone 24 hours a day to take your calls and connect you with the right resources concerning members' needs. Last but not least, Serv-S-Team offers an extremely wide variety of services meaning very few limitations to maximizing the members reward potentials.

News Letters

In one embodiment, Serv-S Plus will on a quarterly basis send out a Newsletter to update our members as to any changes within the program. At such time, the provider may submit changes or marketing promotions to be posted within the letter.

We also feel that the providers will highly benefit from Serv-S-Team being it puts them into a lower risk customer base. The majority of clients will be of word of mouth business which is the best source. It also raises the frequency of repeat business which again is favorable. The savings of advertisement would be substantial with a much more captive group being contacted directly versus fingering through the yellow pages or ads and being mixed with dozens of other competitors. We believe Serv-S-Team is a very expandable plan adoptable by many different markets and regions and look forward to your future interest in this unique and rewarding program.

This program provides members with variety and versatility as well as convenience, savings and incentive. Also provided are consistency, fairness, reliability, professionalism, quality and value with every dollar spent. Additionally, providers will benefit from this program as it puts them into a lower risk category of customer base. The customer base will be of a higher credibility of client base since the majority will be from word of mouth business. It also raises the frequency of repeat business, which is one of the best sources of clients. The savings of advertisement would be substantial with a much more captive group being contacted directly versus searching the yellow pages and being mixed with dozens of other competitors. Moreover, providers would have a higher closing rate because of the existence of the existing customers' incentive plan. Being one of maybe three or four would mean less competition for the provider and better success rate in turn meaning increased volumes of sales, revenues and profits. Furthermore, this would encourage small business growth, greater job opportunities as well as financial stability.

The system and method according to the present invention can be employed on one or more computers, computing devices, or a device that communicates with a computing device that communicates with the database 50 of FIG. 1. In general, the network 10 is accessible via a computer, and the computer can in some embodiments access the Internet when interacting with the database 50 and other components of system 40.

The present invention is suitable for use in the construction industry and many other industries. For example, the present invention may also be used in connection with real estate services in the purchase of a home.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for using a network program that provides services for customers, wherein operation of the service network comprises:
forming a network of service providers;
requesting a service from a service provider within the network;
executing the service for a member customer;
paying an amount to the service provider for the service; and
receiving a first fraction of the amount back from the service provider that is credited into a member customer account and a second fraction of the amount back from the service provider that is used to manage the network program 10.

2. The method according to claim 1, wherein the service provider is a general contractor.

3. The method according to claim 1, wherein forming the network of service providers include:
identifying service providers;
adding identified service providers to the network; and
distributing membership cards to potential customers;

4. The method according to claim 3, wherein the membership cards are distributed to a customer base.

5. The method according to claim 1, wherein requesting a service from a service provider comprises electronically accessing a database communicating with the network of service providers.

6. The method according to claim 1, wherein paying an amount to the service provider for the service comprises electronically debiting a membership card accessing the member customer account.

7. A service system for facilitating providing of construction services for homeowners, the system comprising:
a database of service providers;
member customers having electronic access to the database;
membership cards uniquely associated with each of the member customers;
a hotline coupled to a network program including the database; and
member accounts electronically correlated to the membership cards;
wherein a service provider is chosen from the database to provide a service for a member customer having access to the hotline, the service provider enabled to credit a first fraction of the amount received from the member customer into the member customer member account and a second fraction of the amount received is credited to the network program to manage the service system.
